(19) United States
(12) Patent Application Publication
(10) Pub. No.: US 2026/0099104 A1
(43) Pub. Date: Apr. 9, 2026

(54) MAGNETIC ONE-COMPONENT TONER AND IMAGE FORMING APPARATUS USING THE SAME

(71) Applicant: KYOCERA Document Solutions Inc., Osaka (JP)

(72) Inventor: Toru TAKATSUNA, Osaka (JP)

(73) Assignee: KYOCERA Document Solutions Inc., Osaka (JP)

(21) Appl. No.: 19/347,253

(22) Filed: Oct. 1, 2025

(30) Foreign Application Priority Data
Oct. 7, 2024 (JP) 2024-176030

(51) Int. Cl. G03G 9/093; C08F 220/18; G03G 9/083; G03G 15/09; G03G 15/16; G03G 15/20

(52) U.S. Cl. CPC G03G 9/09321; C08F 220/1804; G03G 9/083; G03G 9/09342; G03G 15/0914; G03G 15/167; G03G 15/2064; C08F 2800/10; G03G 2215/0614; G03G 2215/2035

(57) ABSTRACT

A magnetic one-component toner includes toner particles each including a toner base particle and an external additive attached to a surface of the toner base particle. The external additive includes conductive particles with a specific resistance of 1.0E+4 [Ω·cm] or lower, resin particles with a number average primary particle sizes of 50 nm or more but 100 nm or less, and silica particles. The resin particles are formed by using an anion surfactant and formed from a vinyl resin having a repeating unit represented by general formula (1) below, a repeating unit represented by general formula (2) below, and a repeating unit derived from a sulfo group-containing vinyl compound. A content ratio of the repeating unit derived from the sulfo group-containing vinyl compound in the vinyl resin is 2.0 mol % or more but 5.0 mol % or less relative to all repeating units in the vinyl resin.

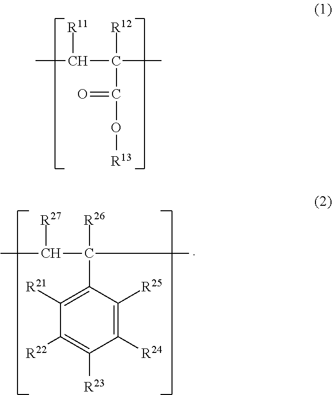

### INCORPORATION BY REFERENCE

This application is based on and claims the benefit of priority from Japanese Patent Application No. 2024-176030 filed on Oct. 7, 2024, the contents of which are hereby incorporated by reference.

### BACKGROUND

The present disclosure relates to magnetic one-component toner for used in image forming apparatuses such as copiers, printers, facsimile machines, and the like, and an image forming apparatus that uses magnetic one-component toner.

In relation to fixing devices employing a belt fixing system using a fixing belt as a heated rotating body, a method is known in which the fixing belt is heated with a planar heater that slides against the fixing belt. In this configuration, it is necessary to reduce the sliding load between the fixing belt and the planar heater.

### SUMMARY

According to one aspect of the present disclosure, a magnetic one-component toner is used in an image forming apparatus including: a developing device that uses magnetic one-component toner to develop an electrostatic latent image having been formed on an image carrier into a toner image; a transfer device that transfers the toner image having been developed by the developing device onto a recording medium; and a fixing device that includes a fixing belt formed as an endless belt and heated by a heating device, a nip forming member disposed radially inside the fixing belt so as to slide on an inner circumferential surface of the fixing belt, and a pressure member pressed with a predetermined pressure against the nip forming member with the fixing belt therebetween to form a fixing nip portion between the fixing belt and the pressure member, the fixing device fixing, onto the recording medium, the toner image having been transferred by the transfer device onto the recording medium. The magnetic one-component toner includes toner particles each including: a toner base particle that contains at least a binder resin and a magnetic powder; and an external additive attached to a surface of the toner base particle. The external additive includes conductive particles with a specific resistance of 1.0E+4 [Ω·cm] or lower, resin particles with a number average primary particle size of 50 nm or more but 100 nm or less, and silica particles. The resin particles are formed by using an anion surfactant, formed from a vinyl resin having a repeating unit represented by general formula (1) below, a repeating unit represented by general formula (2) below, and a repeating unit derived from a sulfo group-containing vinyl compound. A content ratio of the repeating unit derived from the sulfo group-containing vinyl compound in the vinyl resin is 2.0 mol % or more but 5.0 mol % or less relative to all repeating units in the vinyl resin.

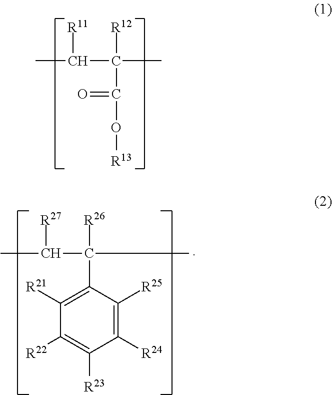

In formula (1), R¹¹ and R¹² each independently represent a hydrogen atom, a halogen atom, or an alkyl group optionally having a substituent, and R¹³ represents an alkylene group having a hydroxyl group.

In formula (2), R²¹ to R²⁷ each independently represent a hydrogen atom, a halogen atom, a hydroxyl group, an alkyl group optionally having a substituent, an alkoxy group optionally having a substituent, an alkoxy alkyl group optionally having a substituent, or an aryl group optionally having a substituent.

### BRIEF DESCRIPTION OF THE DRAWINGS

FIG. 1 is a schematic sectional view of an image forming apparatus in which magnetic one-component toner according to the present disclosure is used.

FIG. 2 is a side sectional view of a fixing device incorporated in an image forming apparatus.

### DETAILED DESCRIPTION

### [1. Overall Configuration of Image Forming Apparatus]

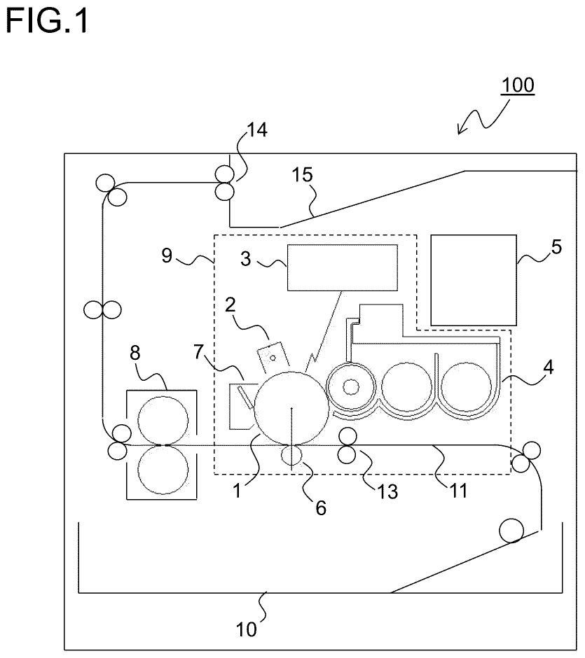

Hereinafter, an embodiment of the present disclosure will be described with reference to the accompanying drawings. FIG. 1 is a schematic sectional view of an image forming apparatus 100 in which magnetic one-component toner according to the present disclosure is used. In the image forming apparatus (e.g., a monochrome printer) 100, when a printing operation is performed, in an image forming portion 9 inside the image forming apparatus 100, an electrostatic latent image is formed based on original-image data received from a host device such as a personal computer or the like, and a developing device 4 attaches toner to the electrostatic latent image to form a toner image. Toner is supplied to the developing device 4 from a toner container 5. In the image forming apparatus 100, while rotating a photosensitive drum 1 in a clockwise direction in FIG. 1, the image forming process is executed with respect to the photosensitive drum 1.

The image forming portion 9 includes, arranged along the rotation direction of the photosensitive drum 1 (the clockwise direction), a charging device 2, an exposure unit 3, the developing device 4, a transfer roller 6, a cleaning device 7, and a charge eliminating device (not shown). The photosensitive drum 1 is formed by laying a photosensitive layer on the surface (outer circumferential surface) of an aluminum drum, for example. The surface (outer circumferential surface) of the photosensitive drum 1 is uniformly charged by the charging device 2. Then, on the surface is irradiated with a light beam from the exposure unit 3, which will be described later, an electrostatic latent image is formed through attenuation of electric charge. Although the photosensitive layer is not particularly limited in material, it is preferably formed of amorphous silicon (a-Si), for example, for its excellent durability.

The charging device 2 uniformly charges the surface of the photosensitive drum 1. Used as the charging device 2 is, for example, a corona discharge device which produces electric discharge by applying a high voltage to an electrode such as a piece of fine wire. Instead of a corona discharge device, there may be employed a contact-type charging device which achieves voltage application while a charging member, as exemplified by a charging roller, is in contact with the surface of the photosensitive drum 1. The exposure unit 3 irradiates the photosensitive drum 1 with a light beam (for example, a laser beam) according to image data, and thereby forms an electrostatic latent image on the surface of the photosensitive drum 1.

The developing device 4 attaches toner to the electrostatic latent image on the photosensitive drum 1 to form a toner image. In the present embodiment, magnetic one-component toner (magnetic one-component developer) is stored in the developing device 4. The developing device 4 will be described in detail later. The cleaning device 7 includes a cleaning roller, a cleaning blade, or the like in line contact with the photosensitive drum 1 in a longitudinal direction thereof, and removes residual toner remaining on the surface of the photosensitive drum 1 after the toner image is moved (transferred) onto the sheet.

Toward the photosensitive drum 1, on which the toner image has been formed in the above-described manner, a sheet is conveyed at a predetermined timing from a sheet storage portion 10 via a sheet conveyance path 11 and a registration roller pair 13 to the image forming portion 9. The transfer roller 6 is in contact with the photosensitive drum 1, thereby forming a nip portion (a transfer nip portion), and moves (transfers) the toner image having been formed on the surface of the photosensitive drum 1 onto the sheet passing through the transfer nip portion without image distortion. After that, in preparation for subsequent formation of a new electrostatic latent image, toner and the like left on the surface of the photosensitive drum 1 are removed by the cleaning device 7, and residual charge is eliminated by the charge eliminating device.

The sheet, onto which the toner image has been transferred, is separated from the photosensitive drum 1 to be conveyed to the fixing device 8, where heat and pressure are applied to the sheet to fix the toner image onto the sheet. The sheet having passed through the fixing device 8 is ejected via an ejection roller pair 14 to a sheet ejection portion 15.

### [2. Configuration of Fixing Device]

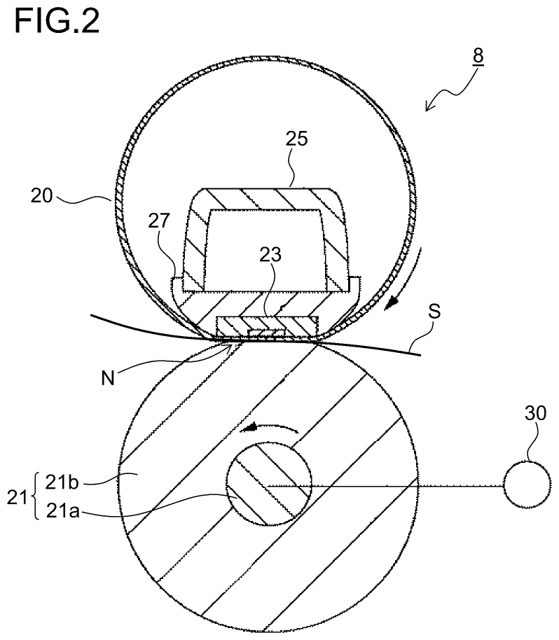

FIG. 2 is a side sectional view of the fixing device 8 incorporated in the image forming apparatus 100. The fixing device 8 employs a belt fixing system, and includes a fixing belt 20, a pressure roller (pressure member) 21, a heater (heating device) 23, a support stay 25, and a nip forming member 27. In FIG. 2, illustration of the housing of the fixing device 8 is omitted.

The fixing belt 20 is an endless belt formed of a plurality of layers stacked on each other including a base layer disposed on the innermost side (the heater-23 side) and a separation layer disposed on the outermost side (the pressure-roller-21 side). The fixing belt 20 is placed under a predetermined tension by the nip forming member 27 and a belt support guide (not shown).

The size of the fixing belt 20 in its widthwise direction (the direction perpendicular to the surface of the sheet on which FIG. 2 is drawn) is set to be larger than the width of the largest one of sheets S passable through a fixing nip portion N. This makes it possible for the fixing belt 20 to cover the entire surface of a sheet S regardless of the size of the sheet S, preventing unfixed toner from attaching to the nip forming member 27.

The pressure roller 21 is constituted of a core metal 21a formed of a material such as metal in a cylindrical shape, an elastic layer 21b that is formed of silicone rubber or the like to be laid on the outer circumferential surface of the core metal 21a, and a separation layer (not shown) formed to cover the surface of the elastic layer 21b. The pressure roller 21 is pressed against the fixing belt 20 with a predetermined pressure.

The support stay 25 is a metal member with a hollow rectangular-tube shape. On the lower surface of the support stay 25, the nip forming member 27 is supported. Opposite end parts of the support stay 25 have side plates (not shown) of the fixing device 8 fixed thereon.

The nip forming member 27 abuts against the pressure roller 21 via the fixing belt 20, thereby forming the fixing nip portion N, through which a sheet S passes. Examples of the material for the nip forming member 27 include a heat resistant resin such as a liquid crystal polymer and an elastic material such as a silicone rubber, and an elastomer may be disposed on a surface of the nip forming member 27 that faces the fixing belt 20.

The heater 23 is a planar heater including a ceramic base material with a resistance layer applied to it, and generates heat by conducting electricity through the resistance layer. The heater 23 is disposed between the fixing belt 20 and the nip forming member 27, and a glass layer is laid on the surface of the resistance layer that faces the inner circumferential surface of the fixing belt 20. The heat generated in the resistance layer heats the fixing belt 20 via the glass layer. The glass layer is in contact with the inner circumferential surface of the fixing belt 20, providing electrical insulation and slidability with respect to the inner circumferential surface of the fixing belt 20.

To one end of the core metal 21a, a fixing drive motor 30 is connected via a drive input gear (not shown). When driving force is transferred from the fixing drive motor 30 to the core metal 21a, causing the pressure roller 21 to rotate in the counter clockwise direction in FIG. 2, frictional force between the pressure roller 21 and the outer circumferential surface of the fixing belt 20 causes the nip forming member 27 (the heater 23) and the inner circumferential surface of the fixing belt 20 to slide against each other, so that the fixing belt 20 is driven to rotate in the clockwise direction in FIG. 2. Where the fixing belt 20 and the pressure roller 21 abut against each other while rotating in opposite directions, the fixing nip portion N is formed.

A sheet S is conveyed from an upstream side in a sheet conveyance direction (the right side in FIG. 2) to the fixing nip portion N, at which the fixing belt 20 and the pressure roller 21 apply heat and pressure to the sheet S, so that the toner, which is in a powdery state, is thermally fused and fixed on the sheet S. After going through the fixing process, the sheet S is separated from the surface of the fixing belt 20 by a separation claw (not shown), to be then conveyed to a downstream side (the left side in FIG. 2) of the fixing device 8 with respect to the sheet conveyance direction.

### [3. Basic Configuration of Magnetic One-Component Toner]

The magnetic one-component toner according to the present disclosure (hereinafter also referred to simply as the toner) used in the image forming apparatus 100 has a toner base particle and an external additive attached to the surface of the toner base particle. The toner base particle at least contains a binder resin and a magnetic powder. As necessary, the toner base particle may also contain, in the binder resin, a colorant, a charge control agent, and the like.

The toner according to the present disclosure contains, as an external additive attached to the surface of the toner base particle, conductive particles and resin particles. The conductive particles have their resistance adjusted to be 1.0E+4 [Ω·cm] or lower. The resin particles are formed from a vinyl resin having a repeating unit derived from a sulfo group-containing vinyl compound.

### [2. Materials of Toner]

Now, a description will be given, one by one, of the binder resin, the magnetic powder, the release agent, the charge control agent, and the colorant that constitute the toner base particle, the silica particles that constitute the external additive externally added to the toner base particle, and a method for producing the toner according to the present disclosure.

### (Binder Resin)

The toner base particle that constitutes the toner according to the present disclosure contains a binder resin. The binder resin that can be contained in the toner base particle is not particularly limited and can be any of binder resins known to be used as a binder resin in toner. Specific examples of the binder resin include thermoplastic resins such as styrene-based resins, acrylic-based resins, styrene-acrylic-based resins, polyethylene-based resins, polypropylene-based resins, vinyl chloride-based resins, polyester resins, polyamide resins, polyurethane resins, polyvinyl alcohol-based resins, vinyl ether-based resins, N-vinyl-based resins, and styrene-butadiene resins. Among these resins, from the viewpoints of the dispersion properties of the colorant in the binder resin, the charging properties of the toner, and the fixing properties on sheets, preferably, at least one of a polyester resin and a styrene-acrylic-based resin is used, more preferred being a polyester resin. The polyester resin will be described below.

Usable polyester resins here are those obtained by condensation polymerization or condensation copolymerization of a dihydric or a trihydric or higher alcohol component and a divalent or a trivalent or higher carboxylic acid component. Examples of components used to synthesize a polyester resin include alcohol components and carboxylic acid components as mentioned below.

Specific examples of dihydric or trihydric or higher alcohol components include: diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenols such as bisphenol A, hydrogenated bisphenol A, polyoxyethylene bisphenol A, and polyoxypropylene bisphenol A; and trihydric or higher alcohols such as sorbitol, 1,2,3,6-hexanetetrol, 1,4-sorbitan, pentacrythritol, dipentaerythritol, tripentacrythritol, 1,2,4-butanetriol, 1,2,5-pentanetriol, glycerol, diglycerol, 2-methylpropane triol, 2-methyl-1,2,4-butanetriol, trimethylolethane, trimethylolpropane, and 1,3,5-trihydroxymethylbenzene.

Specific examples of divalent or trivalent or higher carboxylic acid components include: divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebacic acid, azelaic acid, and malonic acid, and alkyl or alkenyl succinic acids such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid, and isododecenyl succinic acid; and trivalent or higher carboxylic acids such as, 1,2,4-benzenetricarboxylic acid (trimellitic acid), 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxyl-2-methyl-2-methylenecarboxypropane, 1,2,4-cyclohexane tricarboxylic acid, tetra(methylene carboxyl) methane, 1,2,7,8-octane tetracarboxylic acid, pyromellitic acid, and empole trimer acid.

These divalent or trivalent or higher carboxylic acid components can be used as ester-forming derivatives such as acid halides, acid anhydrides, and lower alkyl esters. Here, the term “lower alkyl” denotes an alkyl group with one to six carbon atoms.

When the binder resin is a polyester-based resin, the softening point of the polyester-based resin is preferably 70° C. or higher but 130° C. or lower, and more preferably 80° C. or higher but 120° C. or lower. For improved mechanical strength of the toner base particle and improved fixing properties of the toner, the number average molecular weight (Mn) of the polyester resin is preferably 1000 or more but 2000 or less. The molecular weight distribution of the polyester resin (the ratio Mw/Mn of the mass average molecular weight (Mw) of the polyester resin to its number average molecular weight (Mn)) is preferably 9 or more but 21 or less.

As the binder resin, it is preferable to use a thermoplastic resin for its satisfactory fixing properties on sheets. Here, a thermoplastic resin can be used not only singly but also with a cross-linking agent or a thermosetting resin added to it. Adding a cross-linking agent or a thermosetting resin so that the binder resin partly have a cross-linked structure helps improve the heat-resistant preservation properties, durability, and the like of the toner without degrading the fixing properties of the toner. When a thermosetting resin is used, the cross-linked fraction (gel fraction) of the binder resin extracted using a Soxhlet extractor is preferably, relative to the mass of the binder resin, 10 mass % or less, and more preferably 0.1 mass % or more but 10 mass % or less.

As a thermosetting resin useable with a thermoplastic resin, an epoxy resin or a cyanate-based resin is preferable. Specific examples of suitable thermosetting resins include bisphenol A-type epoxy resins, hydrogenated bisphenol A-type epoxy resins, novolak-type epoxy resins, polyalkylene ether-type epoxy resins, cyclic aliphatic compound-type epoxy resins, and cyanate resins. Two or more of these thermosetting resins can be used in combination.

The glass transition point (Tg) of the binder resin is preferably 40° C. or higher but 70° C. or lower. Too high a glass transition point tends to lead to poor low-temperature fixing properties of the toner. Too low a glass transition point tends to lead to poor heat-resistant preservation properties of the toner.

The glass transition point of the binder resin can be determined from the changing point of the specific heat of the binder resin using a differential scanning calorimeter (DSC). More specifically, the glass transition point of the binder resin can be determined by drawing the endothermic curve of the binder resin using as a measuring instrument a differential scanning calorimeter (DSC-6200, manufactured by Seiko Instruments Inc.). 10 mg of a measurement sample is put in an aluminum pan, while a vacant aluminum pan is used as a reference. From the endothermic curve of the binder resin drawn through measurement in a normal-temperature normal-humidity environment in the range of measurement temperature from 25° C. to 200° C. at a heating rate of 10° C. per minute, the glass transition point of the binder resin can be determined.

The mass average molecular weight (Mw) of the binder resin is not particularly limited within the scope consistent with the object of the present disclosure. Typically, the mass average molecular weight (Mw) of the binder resin is preferably 20,000 or more but 300,000 or less, and more preferably 30,000 or more but 200,000 or less. The mass average molecular weight of the binder resin can be determined by gel permeation chromatography (GPC) using a standard curve previously prepared using a standard polyethylene resin.

### (Magnetic Powder)

The toner base particle contains a magnetic powder in the binder resin. Suitably usable as a material of the magnetic powder is, for example, a ferromagnetic metal (more specifically, iron, cobalt, nickel, an alloy of one or more of these metals, or the like), a ferromagnetic metal oxide (more specifically, ferrite, magnetite, chromium dioxide, or the like), or a material subjected to ferromagnetization (more specifically, a carbon material made ferromagnetic by heat treatment, or the like). To suppress the elution of a metal ion (e.g., iron ion) from the magnetic powder, preferably, surface-treated magnetic particles are used as the magnetic powder. One type of magnetic powder can be used singly or a plurality of types of magnetic powder can be used in combination.

The particle size of the magnetic powder is not limited within the scope consistent with the object of the present disclosure. Specifically, the particle size of the magnetic powder is preferably 0.1 μm or more but 1.0 μm or less, and more preferably 0.1 μm or more but 0.5 μm or less. Using a magnetic powder with a particle size in those ranges makes it easy to disperse the magnetic powder uniformly in the binder resin.

As the magnetic powder, it is possible to use a product surface-treated using a surface treatment agent such as a titanium-based coupling agent or silane-based coupling agent for the purpose of improving the dispersion properties of the magnetic powder in the binder resin.

The amount of magnetic powder used is not particularly limited within the scope consistent with the object of the present disclosure. Specifically, the amount of magnetic powder used is preferably, relative to the total mass of the toner, 30 mass % or more but 60 mass % or less, and more preferably 40 mass % or more but 60 mass % or less. Using too large an amount of magnetic powder can make it difficult to form images with the desired image density for a long period, or can lead to extremely poor fixing properties of the toner on sheets. Using too small an amount of magnetic powder can cause fogging in the formed image, or can make it difficult to form images with the desired image density for a long period.

### (Release Agent)

For the purpose of improving its fixing properties and anti-offsetting properties, the toner base particle may contain a release agent. The type of release agent that can be added to the toner base particle is not particularly limited. As such a release agent, wax is preferred. Examples of wax include carnauba wax, synthetic ester wax, polyethylene wax, polypropylene wax, fluorocarbon resin-based wax, Fischer-Tropsch wax, paraffin wax, montan wax, and rice wax. Two or more of these release agents can be used in combination. Adding such a release agent to the toner base particle helps more effectively suppress offsetting and image smearing (stain around an image caused by its being rubbed).

When polyester resin is used as the binder resin, from the viewpoint of compatibility, one or more selected from the group consisting of carnauba wax, synthetic ester wax, and polyethylene wax are suitably used. When polystyrene-based resin is used as the binder resin, likewise from the viewpoint of compatibility, Fischer-Tropsch wax and/or paraffin wax is suitably used.

Note that Fischer-Tropsch wax is a straight-chain hydrocarbon compound with few iso-structure molecules or side chains that is produced by exploiting the Fischer-Tropsch reaction, which is a catalytic hydrogenation reaction of carbon monoxide.

More preferable among different types of Fischer-Tropsch wax are those that have a mass average molecular weight of 1,000 or more and of which the bottom temperature of the exothermal peak observed by DSC measurement falls within the range of 100° C. or higher but 120° C. or lower. Examples of such types of Fischer-Tropsch wax include the following products available from Sasol Ltd.: Sasol Wax Cl (exothermic peak bottom temperature: 106.5° C.), Sasol Wax C105 (exothermic peak bottom temperature: 102.1° C.), and Sasol Wax SPRAY (exothermic peak bottom temperature: 102.1° C.).

The amount of release agent used is not particularly limited within the scope consistent with the object of the present disclosure. Specifically, the amount of release agent used is preferably 1 mass % or more but 10 mass % or less relative to the total mass of the toner base particle. Using too small an amount of release agent may result in insufficient suppression of offsetting and image smearing in image formation; using too large an amount of release agent may result in fusing-together of toner particles and hence degraded heat-resistant preservation properties of the toner.

### (Colorant)

The toner base particle, which contains a magnetic powder as an essential component, is generally black. Accordingly, within the scope consistent with the object of the present disclosure, for the purpose of obtaining a more preferred tone of black in the image formed using the toner of the present disclosure, the toner can contain as a colorant any known dye or pigment. Specifically, one example of a pigment is carbon black and one example of a dye is an acid violet.

The amount of colorant used is not particularly limited within the scope consistent with the object of the present disclosure. Specifically, the amount of colorant used is, relative to the total mass of the toner base particle, preferably 1 mass % or more but 10 mass % or less, and more preferably 2 mass % or more but 7 mass % or less.

A colorant can be used as a masterbatch having a colorant previously dispersed in a resin material such as a thermoplastic resin. When a colorant is used as a masterbatch, the resin contained in the master batch is preferably a resin of the same type as the binder resin.

### (Charge Control Agent)

The toner base particle can contain a charge control agent for the purpose of improving the charge level of the toner and its charge response properties as an index of whether it can be charged to a predetermined charge level in a short time and thereby obtaining toner with excellent durability and stability. Since the toner according to the present disclosure is a positively chargeable toner, a positively chargeable charge control agent is used.

The type of charge control agent that can be contained in the toner base particle is not particularly limited within the scope consistent with the object of the present disclosure. Any of charge control agents known to be used in toner can be appropriately selected and used. Specific examples of positively chargeable charge control agents include: azine compounds such as pyridazine, pyrimidine, pyrazine, orthoxazine, metaoxazine, paraoxiazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes composed of azine compounds, such as azine fast red FC, azine fast red 12BK, azine violet BO, azine brown 3G, azine light brown GR, azine dark green BH/C, azine deep black EW, and azine deep black 3RL; nigrosine compounds such as nigrosine, nigrosine salts, and nigrosine derivatives; acid dyes composed of nigrosine compounds, such as nigrosine BK, nigrosine NB, and nigrosine Z; metal salts of naphthenic acid or higher fatty acids; alkoxylated amines; akylamides; and quaternary ammonium salts such as benzylmethylhexyldecylammonium and decyltrimethylammonium chloride. Among these positively chargeable charge control agents, nigrosine compounds are particularly preferred for their faster charge response properties. Among these positively chargeable charge control agents, two or more types can be used in combination.

Also usable as a positively chargeable charge control agent are resins that have as a functional group a quaternary ammonium salt, a carboxylic acid salt, or a carboxyl group. Specific examples include styrene-based resin having a quaternary ammonium salt, acrylic-based resin having a quaternary ammonium salt, styrene-acrylic-based resin having a quaternary ammonium salt, polyester resin having a quaternary ammonium salt, styrene-based resin having a carboxylic acid salt, acrylic-based resin having a carboxylic acid salt, styrene-acrylic-based resin having a carboxylic acid salt, polyester resin having a carboxylic acid salt, styrene-based resin having a carboxylic group, acrylic-based resin having a carboxylic group, styrene-acrylic-based resin having a carboxylic group, and polyester resin having a carboxylic group. The molecular weights of these resins are not particularly limited within the scope consistent with the object of the present disclosure, and they can be in the form of an oligomer or a polymer.

Among resins usable as a positively chargeable charge control agent, from the viewpoint of easy adjustment of charge amount within a desired range, styrene-acrylic-based resin having as a functional group a quaternary ammonium salt is more preferable. In styrene-acrylic-based resins having as a functional group a quaternary ammonium salt, specific examples of preferable acrylic-based comonomers for copolymerization with the styrene unit include alkyl (meth)acrylates such as methyl acrylate, ethyl acrylate, n-propyl acrylate, isopropyl acrylate, n-butyl acrylate, isobutyl acrylate, 2-ethylhexyl acrylate, methyl methacrylate, ethyl methacrylate, n-butyl methacrylate, and isobutyl methacrylate.

Used as a quaternary ammonium salt is a unit derived by a quarternization process from a dialkyl aminoalkyl (meth)acrylate, dialkyl (meth)acryl amide, or dialkyl aminoalkyl (meth)acryl amide. Specific examples of dialkyl aminoalkyl (meth)acrylate include dimethyl aminoethyl (meth)acrylate, diethyl aminoethyl (meth)acrylate, dipropyl aminoethyl (meth)acrylate, and dibutyl aminoethyl (meth)acrylate. Specific examples of dialkyl (meth)acryl amide include dimethyl methacryl amide. Specific examples of dialkyl aminoalkyl (meth)acryl amide include dimethyl aminopropyl methacryl amide. In polymerization, a polymerizable monomer containing the hydroxy group such as hydroxyethyl (meth)acrylate, hydroxypropyl (meth)acrylate, 2-hydroxybutyl (meth)acrylate, or N-methylol (meth)acrylamid can be used together.

The amount of charge control agent used is not particularly limited within the scope consistent with the object of the present disclosure. Typically, the amount of charge control agent used is preferably, relative to the total mass of the toner base particle, 0.1 mass % or more but 10 mass % or less. Using too small an amount of charge control agent makes it difficult to stably charge the toner with a predetermined polarity. This can lead to a lower-than-expected image density in the formed image and make it difficult to maintain satisfactory image density for a long period. Also the charge control agent is then difficult to disperse evenly, and this tends to cause fogging in the formed image and contamination of a latent image carrying member with toner components. Using too large an amount of charge control agent leads to poorer resistance to environment, resulting in image faults in the formed image due to insufficient charging under high temperature and high humidity and contamination of a latent image carrying member with toner components.

The toner base particle can be a toner base particle with no shell layer (non-capsule toner base particle) or a toner base particle with a shell layer (capsule toner base particle). A capsule toner base particle can be produced by forming a shell layer on the surface of a non-capsule toner base particle (toner core particle). The shell layer can be formed substantially solely of a thermosetting resin, can be formed substantially solely of a thermoplastic resin, or can contain both a thermoplastic resin and a thermosetting resin.

### (External Additive)

The toner according to the present disclosure has a toner base particle of which the surface is treated with an external additive. The toner according to the present disclosure contains, as the external additive, the conductive particles, the resin particles, and silica particles.

### (Conductive Particles)

The conductive particles are produced by subjecting a base material formed of a metal oxide, such as titanium oxide, alumina, and the like, to antimony-doped tin oxide (ATO) treatment and hydrophobization treatment with a coupling agent. Performed as the hydrophobization treatment is surface treatment with a silane coupling agent, a titanate coupling agent, and the like for the purpose of improving environmental stability.

The resistance (conductivity) of the conductive particles can be adjusted by the amount of ATO treatment. In the present embodiment, through the ATO treatment, the specific resistance of the conductive particles is adjusted to be 1.0E+4 [Ω·cm] or lower. Thereby, electrostatic adhesion force between the fixing belt and the toner can be reduced.

Examples of the silane coupling agent used for hydrophobization treatment include: hexamethyldisilazane, trimethylsilane, trimethylchlorosilane, trimethylethoxysilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, triorganosilyl mercaptan, trimethylsilyl mercaptan, triorganosilyl acrylate, vinyldimethylacetoxysilane, dimethylethoxysilane, dimethyldimethoxysilane, diphenyldiethoxysilane, hexamethyldisiloxane, 1,3-divinyltetramethyldisiloxane, 1,3-diphenyltetramethyldisiloxane, and dimethylpolysiloxane having 2 to 12 siloxane units per molecule and containing a hydroxyl group bonded to each Si in its units positioned at the terminals.

Hydrophobization treatment may be carried out using a nitrogen-containing silane coupling agent, which is particularly suitable for positively chargeable toner. Examples of the nitrogen-containing silane coupling agent include aminopropyltrimethoxysilane, aminopropyltriethoxysilane, dimethylaminopropyltrimethoxysilane, diethylaminopropyltrimethoxysilane, dipropylaminopropyltrimethoxysilane, dibutylaminopropyltrimethoxysilane, monobutylaminopropyltrimethoxysilane, dioctylaminopropyltrimethoxysilane, dibutylaminopropyldimethoxysilane, dibutylaminopropylmonomethoxysilane, dimethylaminophenyltrimethoxysilane, trimethoxysilyl-γ-propylphenylamine, trimethoxysilyl-γ-propylbenzylamine, trimethoxysilyl-γ-propylpiperidine, trimethoxysilyl-γ-propylmorpholine, and trimethoxysilyl-γ-propylimidazole. These treatment agents may be used individually, as mixtures of two or more types, or in combination or through multiple treatment steps. Further, a silicone oil may be used together with, or singly without, a silane coupling agent for hydrophobization treatment.

The conductive particles preferably have a number average primary particle size of 0.1 μm or more but 0.5 μm or less. The added amount of conductive particles is preferably 0.3 mass % or more but 2 mass % or less relative to the mass of the toner base particle.

### (Resin Particles)

The resin particles are formed from a vinyl resin having a repeating unit represented by general formula (1) below, a repeating unit represented by general formula (2) below, and a repeating unit derived from a sulfo group-containing vinyl compound. The content ratio of the repeating unit derived from the sulfo group-containing vinyl compound in the vinyl resin is 2.0 mol % or more but 5.0 mol % or less relative to all the repeating units in the vinyl resin.

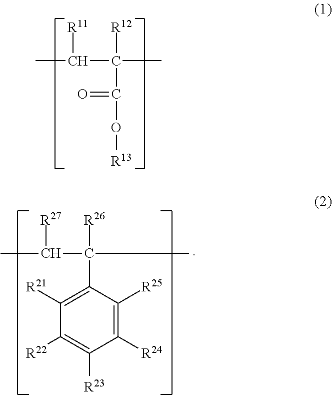

In formula (1), R¹¹ and R¹² each independently represent a hydrogen atom, a halogen atom, or an alkyl group optionally having a substituent. R¹³ represents an alkylene group having a hydroxyl group.

Preferable as R¹¹ and R¹² are each independently a hydrogen atom or a methyl group, and particularly preferable is a combination such that R¹¹ is a hydrogen atom and R¹² is a hydrogen atom or a methyl group. Preferable as R¹³ is an alkylene group having a hydroxyl group with a carbon number of 1 or more but 6 or less, and particularly preferable is an alkylene group having a hydroxyl group with a carbon number of 1 or more but 4 or less. In a repeating unit derived from 2-hydroxyethyl methacrylate, R¹¹ represents a hydrogen atom, R¹² represents a methyl group, and R¹³ represents (—(CH₂)₂—OH).

In formula (2), R²¹ to R²⁷ each independently represent a hydrogen atom, a halogen atom, a hydroxyl group, an alkyl group optionally having a substituent, an alkoxy group optionally having a substituent, an alkoxy alkyl group optionally having a substituent, or an aryl group optionally having a substituent.

Preferable as R²¹ to R²⁷ are each independently a hydrogen atom, a halogen atom, an alkyl group with a carbon number of 1 or more but 4 or less, an alkoxy group with a carbon number of 1 or more but 4 or less, or an alkoxy alkyl group with a carbon number (specifically, the total number of carbon atoms in the alkoxy and alkyl groups) of 2 or more but 6 or less. Preferable as R²⁶ and R²⁷ are each independently a hydrogen atom or a methyl group, and particularly preferable is a combination such that R²⁷ is a hydrogen atom and R²⁶ is a hydrogen atom or a methyl group. In a repeating unit derived from styrene, R²¹ to R²⁷ each represent a hydrogen atom.

The resin particles are produced by using an anion surfactant. By using an anion surfactant, it is possible to give weak negative chargeability to the resin particles. Thereby, it is possible to reduce the electrostatic adhesion force between the fixing belt and the toner without adverse influence on the positive chargeability of the toner.

The number average primary particle size of the resin particles is 50 nm or more but 100 nm or less. If the number average primary particle size of the resin particles is less than 50 nm, the resin particles are likely to sink into the toner base particle. This impairs the effectiveness of the resin particles as spacer particles, making it less likely for the toner to come into contact with the surface of the fixing belt. If the number average primary particle size of the resin particles exceeds 100 nm, an increased amount of resin particles detach from the toner base particle, failing to function as spacer particles. The added amount of resin particles is preferably 0.05 mass % or more but 2 mass % or less relative to the mass of the toner base particle.

### (Silica Particles)

In addition to the conductive particles and the resin particles, the external additive includes silica particles to improve the toner flowability. The silica particles may be treated with a surface treatment agent such as silane coupling agent or a silicone oil. The number average prime particle size of the silica particles is preferably 10 nm or more but 30 nm or less.

Further, when the number average primary particle size of the conductive particles is represented by r1, the number average primary particle size of the resin particles is represented by r2, and the number average primary particle size of the silica particles is represented by r3, it is preferable that r1>r2>r3 be fulfilled. The surfaces of the silica particles and the toner base particles have strong positive chargeability, and thus exhibit high electrostatic adhesion force with respect to the fixing belt (which is negatively chargeable). By actively bringing the surface of the fixing belt and the conductive particle into contact with each other, the potential difference between the toner and the surface of the fixing belt is reduced, enhancing the effect of reducing the electrostatic adhesion force of the toner with respect to the fixing belt. Accordingly, by setting the number average primary particle size r1 of the conductive particles to be the largest relative to the other two, the conductive particles come into contact with the fixing belt with an increased frequency, achieving the effect of reducing the electrostatic adhesion force.

### [Production Method for Toner]

Next, a production method for the toner according to the present disclosure will be described. The production method for the toner includes a method for producing the toner base particle and a method for external addition treatment for attaching the external additive to the surface of the toner base particle. The production method for the toner base particle is not particularly limited so long as it forms the toner base particle with a predetermined structure. As necessary, a toner base particle coated with a shell layer may be used. As a production method suitable for the positively chargeable toner described above, a production method for the toner base particle and an external additive treatment method will be described one by one.

### (Production Method for Toner Base Particle)

The production method for the toner base particle is not particularly limited so long as it can satisfactorily disperse a magnetic powder and any components, such as a colorant, a release agent, a charge control agent, and the like, in a binder resin. Examples of production methods suitable for the toner base particle include a pulverization method and an agglomeration method.

In the pulverization method, the binder resin is mixed with the components such as magnetic powder, colorant, release agent, and charge control agent using a mixer or the like; then the binder resin and the components blended in it are melted and kneaded using a kneader such as a uniaxial or biaxial extruder; and then the cooled kneaded product is pulverized and classified. The average particle size of the toner base particle is not particularly limited within the scope consistent with the object of the present disclosure; in general, it is preferably 5 μm or more but 10 μm or less.

In an agglomeration method, in an aqueous solvent containing fine particles of each of the binder resin, the magnetic powder, the colorant, the release agent, the charge control agent, and the like, those fine particles are agglomerated until they form particles of the desired particle size. This produces agglomerated particles containing the binder resin, the magnetic powder, the release agent, the charge control agent, and the colorant. Subsequently, the obtained agglomerated particles are heated so that the components of the agglomerated particles coalesce. In this way, a toner base particle with the desired particle size is obtained.

### (Method for External Addition Treatment)

The method for treatment of the toner base particle with the external additive is not particularly limited; the toner base particle can be treated by any conventionally known method. Specifically, the toner base particle is treated with the external additive using a mixer such as a Henschel mixer or a Nauta mixer under treatment conditions adjusted such that particles of the external additive do not sink into the toner base particle.

As hitherto described, according to the present disclosure, the chargeability (positive chargeability) of the toner is maintained as much as possible, and the electrostatic adhesion force of the toner with respect to the fixing belt is small. This helps effectively suppress electrostatic offset, which is likely to occur in cases where a fixing device employing the belt fixing system, which is excellent in low-temperature fixing properties, and a development system using a magnetic one-component developer are used in combination. The effects of the present disclosure will be described more specifically below by way of practical examples. The present disclosure is in no way limited by these practical examples.

### EXAMPLES

### Production Example 1

### (Production of Toner Base Particles)

As a binder resin, 100 mass parts of a polyester resin (HP-313, manufactured by The Nippon Synthetic Chemical Industry Co., Ltd.) and 80 mass parts of a magnetic powder (TN-15, manufactured by Mitsui Mining & Smelting) were mixed with 4 mass parts of a charge control agent (FCA-201-PS, manufactured by Fujikura Kasci Co., Ltd.), and 4 mass parts of a release agent (carnauba wax, manufactured by TOA KASEI CO., LTD.) for 5 minutes at a rotation rate of 2000 rpm using an FM mixer (FM-20B, manufactured by Nippon Coke & Engineering Co., Ltd.) to obtain a mixture.

The obtained mixture was melted and kneaded using a biaxial extruder (TEM-26SS, manufactured by Toshiba Machine Co., Ltd.) to obtain a kneaded product. The melting and kneading were performed under the conditions of a cylinder temperature of 120° C., a spindle rotation rate of 100 rpm, and a processing rate of 90 g/min. The kneaded product was cooled and was then coarsely pulverized using a pulverizer (Rotoplex 16/8, manufactured by Hosokawa Micron Corporation). The obtained coarsely pulverized product was then pulverized using a mechanical pulverizer (Turbomill TA, manufactured by Freund-Turbo Corporation) to obtain a pulverized product. The pulverized product was classified using a wind-power classifier (EJ-L-3 (LABo) type, manufactured by NITTETSU MINING) to obtain toner base particles with a number average primary particle size of 7.0 μm.

### Production Example 2

### (Production of Conductive Particles)

Titanium oxide (CR-EL, manufactured by ISHIHARA SANGYO KAISHA, LTD.) was dispersed in water to obtain 100 g/L of titanium oxide suspension, which was then heated to 70° C. To the resulting suspension, a solution of 24 g of tin chloride (SnCl₂/5H₂O) and 8 g of antimony chloride (SbCl₂) in 2N aqueous hydrochloric acid solution and 10 mass % of aqueous sodium hydroxide solution were gradually added over one hour, with the pH stabilized within the range of 2 to 3, to form a conductive layer of a hydrate of tin oxide and antimony oxide on the surfaces of titanium oxide particles. Subsequently, after filtering and washing the suspension, the resulting material was calcined at a temperature of 600° C. and pulverized using a jet mill to obtain titanium oxide particles with an electrically conductive layer formed thereon.

The obtained titanium oxide particles and 3.0 mass % of isopropyltriisostearoyl titanate relative to the titanium oxide particles were put in a Henschel mixer (manufactured by NIPPON COKE & ENGINEERING CO., LTD.) and mixed at a temperature of 130° C. to cause a coupling reaction, then dried, and pulverized to obtain conductive particles C-1.

By the same method as described above, except that the added amount of tin chloride (SnCl₂/5H₂O) was changed to 12 g and the added amount of antimony chloride (SbCl₂) was changed to 4 g, conductive particles C-2 were obtained.

By the same method as described above, except that the added amount of tin chloride (SnCl₂/5H₂O) was changed to 8 g and the added amount of antimony chloride (SbCl₂) was changed to 3 g, conductive particles C-3 were obtained.

### Production Example 3

### (Production of Resin Particles)

Into a four-neck flask provided with a stirring blade, a cooling pipe, a thermometer, and a nitrogen introduction pipe, 600 g of ion exchange water and 6 g of an anionic surfactant (sodium dodecylbenzenesulfonate), 100 g of n-butyl methacrylate, 20 g of styrene, 35 g of divinylbenzene (mixture of m-divinylbenzene and p-divinylbenzene), 15 g of polymerization initiator (benzoyl peroxide), and 5 g of 2-acrylamide-2-methylpropanesulfonic acid were put while the contents were being stirred at a rotation rate of 100 rpm.

Subsequently, while the contents were being stirred at the rotation rate of 100 rpm, nitrogen gas was introduced into the flask to replace the atmosphere inside the flask by nitrogen. Further, while the contents were being stirred at the rotation rate of 100 rpm, under the nitrogen atmosphere, the temperature of the contents was raised to 90° C. After that, under conditions of the nitrogen atmosphere and a temperature of 90° C., the contents were stirred at the rotation rate of 100 rpm and reacted (polymerized) for three hours to obtain an emulsion containing the reaction product (the resin particles). Subsequently, the obtained emulsion was cooled, subjected to solid-liquid separation, and then, the obtained solid was dried for 18 hours at a temperature of 80° C. to obtain the powder of resin particles R-1.

By changing the rotation rate during the polymerization and the added amount of 2-acrylamide-2-methylpropanesulfonic acid, powders of resin particles R-2 to R-9 were obtained having different number average primary particle sizes and different content ratios (mol %) of the sulfo group-containing vinyl compound.

### Production Example 4

### (Production of Toner)

The toner base particles obtained in Production Example 1, 1.0 mass % of conductive particles C-1 obtained in Production Example 2, 0.5 mass % of resin particles R-1 obtained in Production Example 3, and silica particles (REA200, manufactured by a Nippon AEROSIL CO., LTD., the number average primary particle size; 12 nm) were mixed, using a Henschel mixer (manufactured by MITSUI MIIKE MACHINERY CO., LTD.), at a rotation rate of 2120 rpm for 15 minutes to attach (externally add) the conductive particles, the resin particles, and the silica particles to the toner base particles. After that, the product was sieved using a sieve of 100 mesh (with a mesh size of 150 μm) to obtain toner 1.

By the same method as toner 1, except that the type of conductive particles and the type of resin particles were changed, toners 2 to 12 were obtained.

### [Measurement of Specific Resistance of Conductive Particles]

The specific resistance was measured in an environment at a temperature of 25° C. and a humidity of 50% RH. Into a cylindrical measurement cell of a resistance meter (R6561, manufactured by ADVANTEST CORPORATION), 5 g of conductive particles were put. The measurement cell used was a cell having a bottom serving as a metal electrode and a cylindrical portion made from fluororesin. An electrode of the resistance meter was connected to the conductive particles loaded in the measurement cell. To the electrode of the resistance meter, a 1-kg load was applied. Subsequently, a 10-V DC voltage was applied across the electrodes, and the electric resistance of the conductive particles after 1 minute from the start of voltage application was measured. Note that the 1-kg load was continuously applied to the electrode from the start of the voltage application to the end of measurement. A specific resistance (volume resistivity value) of the conductive particles was obtained according to the formula below based on the measured value of resistance and the dimensions of the conductive particles (specifically, the conductive particles loaded in the measurement cell) in the electric resistance measurement.

(Specific Resistance) [Ω·cm]=(Electric Resistance)×(Sectional Area of Electric Current Path)/(Length of Electric Current Path)

### [Measurement of Number Average Primary Particle Sizes of Conductive Particles and Resin Particles]

Using a scanning electron microscope (JSM-6700F, manufactured by JEOL Co., Ltd.), the surface image of the toner particle was captured at a magnification of 30,000×. Using image analysis software (WinROOF, manufactured by Mitani Corporation), from the captured surface image, circle-equivalent diameters of 100 conductive particles and resin particles attached to the surface of the toner particle were measured, and their average values were determined to be their respective number average primary particle sizes. The conductive particles, the resin particles, and the silica particles attached to the toner particle can be distinguished from each other based on their particle sizes. The base materials, the number average primary particle sizes, and the specific resistances of conductive particles C-1 to C-3 are shown in Table 1. The surfactants, the number average primary particle sizes, and the content ratios of the sulfo group-containing vinyl compound of resin particles R-1 to R-9 are shown in Table 2.

TABLE 1

| Conductive | | Particle Size | Specific Resistance |
|---|---|---|---|
| Particles | Base Material | [nm] | [Ω · cm] |
| C-1 | Titanium Oxide | 250 | 1.0E+2 |
| C-2 | Titanium Oxide | 250 | 8.0E+3 |
| C-3 | Titanium Oxide | 250 | 7.0E+4 |

TABLE 2

| Resin | | Particle Size | Sulfo Group-Containing Vinyl |
|---|---|---|---|
| Particle | Surfactant | [nm] | Compound Content Ratio [mol %] |
| R-1 | Anion | 70 | 2.0 |
| R-2 | Anion | 70 | 5.0 |
| R-3 | Anion | 50 | 2.0 |
| R-4 | Anion | 100 | 2.0 |
| R-5 | Anion | 70 | 1.0 |
| R-6 | Anion | 70 | 7.5 |
| R-7 | Anion | 40 | 2.0 |
| R-8 | Anion | 120 | 2.0 |
| R-9 | Cation | 70 | 2.0 |

### [Evaluation of Electrostatic Offset (Image Smearing)]

The toners 1 to 12 obtained in Production Examples 4 were each installed in the developing portion of an evaluation machine (a monochrome printer ECOSYS PA6000x, manufactured by Kyocera Document Solutions) employing the belt fixing method. After toner installation, an image with a coverage ratio of 2% was printed on 50,000 sheets in a normal-temperature normal-humidity environment (temperature: 23° C., humidity: 65% RH). After the 50,000-sheet printing, one evaluation image including a black solid image measuring 30 mm×30 mm (with 100% image density) and a black halftone image measuring 30 mm×30 mm (with 37.5% image density) was printed on one sheet. The printed sheet on which the evaluation image had been formed was inspected visually to determine whether any electrostatic offset had occurred.

The evaluation criteria are as follows:
Good: stains attributable to the toner having attached to the fixing belt (stains recurring with each rotation of the fixing belt) were not observed on the printed sheet.
Poor: stains attributable to the toner having attached to the fixing belt (stains recurring with each rotation of the fixing belt) were observed on the printed sheet.

The results of evaluation on electrostatic offset (image smearing) in cases where toners 1 to 5 were used (Practical Examples 1 to 5) and cases where toners 6 to 12 were used (Comparative Examples 1 to 7) are shown in Table 3 along with the types of conductive particles and resin particles used as the external additive.

TABLE 3

| | | | | Electrostatic |
|---|---|---|---|---|
| | | Conductive | Resin | Offset (Image |
| | Toner | Particle | Particle | Smearing) |
| Practical Example 1 | 1 | C-1 | R-1 | Good |
| Practical Example 2 | 2 | C-2 | R-1 | Good |
| Practical Example 3 | 3 | C-1 | R-2 | Good |
| Practical Example 4 | 4 | C-1 | R-3 | Good |
| Practical Example 5 | 5 | C-1 | R-4 | Good |
| Comparative Example 1 | 6 | C-3 | R-1 | Poor |
| Comparative Example 2 | 7 | C-1 | R-5 | Poor |
| Comparative Example 3 | 8 | C-1 | R-6 | Poor |
| Comparative Example 4 | 9 | C-1 | R-7 | Poor |
| Comparative Example 5 | 10 | C-1 | R-8 | Poor |
| Comparative Example 6 | 11 | C-1 | R-9 | Poor |

As is clear from Table 3, in Practical Examples 1 to 5 respectively using toners 1 to 5 each including, as the external additive, one of conductive particles C-1 and C-2 each having a specific resistance of 1.0E+4 [Ω·cm] or lower and one of resin particles R-1 to R-4 each having a content ratio of the sulfo group-containing vinyl compound in the vinyl resin of 2.0 mol % or more but 5.0 mol % or less, no image smearing due to electrostatic offset was observed.

By contrast, in Comparative Example 1 using toner 6 including, as the external additive, conductive particles C-3 having a specific resistance of 7.0E+04 [Ω·cm], the electrostatic adhesion force between the fixing belt and the toner was not sufficiently reduced, and image smearing was caused by electrostatic offset. In Comparative Examples 2 and 3 using toners 7 and 8 respectively including, as the external additive, resin particles R-5 and R-6 having content ratios of the sulfo group-containing vinyl compound in the vinyl resin of 1.0 mol % and 7.5 mol %, respectively, the content ratios of the sulfo group-containing vinyl compound were not suitable, and image smearing was caused by electrostatic offset.

In Comparative Example 4 using toner 9 including, as the external additive, resin particles R-7 having a number average primary particle size of 40 nm, the particle size of the resin particles was so small that the resin particles sank into the toner particles, failing to provide the spacer effect, and image smearing was caused by electrostatic offset. On the other hand, in Comparative Example 5 using toner 10 including, as the external additive, resin particles R-8 having a number average primary particle size of 120 nm, an increased amount of resin particles detached from the toner particles, failing to provide the spacer effect, and image smearing was caused by electrostatic offset.

In Comparative Example 6 using toner 11 including, as the external additive, resin particles R-9 produced using a cation surfactant, it was impossible to give weak negative chargeability to the resin particles and thus to reduce the electrostatic adhesion force between the fixing belt and the toner, and image smearing was caused by electrostatic offset.

The above results confirm the following. By including, as the external additive, the conductive particles having a specific resistant of 1.0E+4 [Ω·cm] or lower, the resin particles having a repeating unit represented by General Formula (1), a repeating unit represented by General Formula (2), and a repeating unit derived from a sulfo group-containing vinyl compound, having a content ratio of the sulfo group-containing vinyl compound in the vinyl resin of 2.0 mol % or more but 5.0 mol % or less, and having a number average primary particle size of 50 nm or more but 100 nm or less, and silica particles, it is possible to obtain magnetic one-component toner that can suppress occurrence of image smearing caused by electrostatic offset.

The present disclosure finds application in image forming apparatuses employing the magnetic one-component developing method and the belt fixing method. Based on the present disclosure, it is possible to provide an image forming apparatus capable of reducing the electrostatic adhesion force between the fixing belt and the magnetic one-component toner to thereby suppress occurrence of electrostatic offset.

What is claimed is:

1. A magnetic one-component toner used in an image forming apparatus including a developing device that uses magnetic one-component toner to develop an electrostatic latent image having been formed on an image carrier into a toner image, a transfer device that transfers the toner image having been developed by the developing device onto a recording medium, and a fixing device that includes a fixing belt formed as an endless belt and heated by a heating device, a nip forming member disposed radially inside the fixing belt so as to slide on an inner circumferential surface of the fixing belt, and a pressure member pressed with a predetermined pressure against the nip forming member with the fixing belt therebetween to form a fixing nip portion between the fixing belt and the pressure member, the fixing device fixing, onto the recording medium, the toner image having been transferred by the transfer device onto the recording medium,
the magnetic one-component toner comprising toner particles each including:
a toner base particle that contains at least a binder resin and a magnetic powder; and
an external additive attached to a surface of the toner base particle,
wherein
the external additive includes:
conductive particles with a specific resistance of 1.0E+4 [Ω·cm] or lower;
resin particles with a number average primary particle size of 50 nm or more but 100 nm or less; and
silica particles,
the resin particles are formed by using an anion surfactant,
the resin particles are formed from a vinyl resin having a repeating unit represented by general formula (1) below, a repeating unit represented by general formula (2) below, and a repeating unit derived from a sulfo group-containing vinyl compound, and
a content ratio of the repeating unit derived from the sulfo group-containing vinyl compound in the vinyl resin is 2.0 mol % or more but 5.0 mol % or less relative to all repeating units in the vinyl resin: 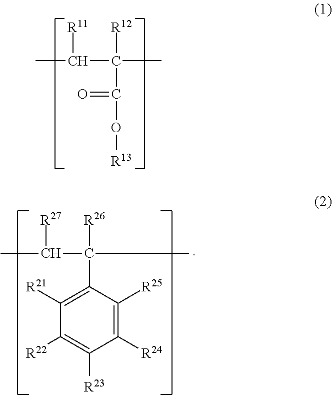
in formula (1), R¹¹ and R¹² each independently representing a hydrogen atom, a halogen atom, or an alkyl group optionally having a substituent, R¹³ representing an alkylene group having a hydroxyl group,
in formula (2), R²¹ to R²⁷ each independently representing a hydrogen atom, a halogen atom, a hydroxyl group, an alkyl group optionally having a substituent, an alkoxy group optionally having a substituent, an alkoxy alkyl group optionally having a substituent, or an aryl group optionally having a substituent.

2. The magnetic one-component toner according to claim 1,
wherein
where a number average primary particle size of the conductive particles is represented by r1, the number average primary particle size of the resin particles is represented by r2, and a number average particle primary size of the silica particles is represented by r3, r1>r2>r3 is fulfilled.

3. The magnetic one-component toner according to claim 1,
wherein
the conductive particles are subjected to ATO treatment such that specific resistances thereof are adjusted to 1.0E+4 [Ω·cm] or lower.

4. The magnetic one-component toner according to claim 1,
wherein
the resin particles are adjusted by changing an added amount of 2-acrylamide-2-methylpropanesulfonic acid such that a content ratio of the sulfo group-containing vinyl compound in the vinyl resin is 2.0 mol % or more but 5.0 mol % or less relative to all the repeating units in the vinyl resin.

5. The magnetic one-component toner according to claim 1,
wherein
the conductive particles have a number average prime particle size of 0.1 μm or more but 0.5 μm or less.

6. The magnetic one-component toner according to claim 1,
wherein
an added amount of the conductive particles is 0.3 mass % or more but 2 mass % or less relative to mass of the toner base particle.

7. The magnetic one-component toner according to claim 1,
wherein
an added amount of the resin particles is 0.05 mass % or more but 2 mass % or less relative to mass of the toner base particle.

8. An image forming apparatus, comprising:
a developing device that uses magnetic one-component toner to develop an electrostatic latent image having been formed on an image carrier into a toner image;
a transfer device that transfers the toner image having been developed by the developing device onto a recording medium; and
a fixing device including:
a fixing belt that is an endless belt and is heated by a heating device;
a nip forming member that is disposed radially inside the fixing belt and slides on an inner circumferential surface of the fixing belt; and
a pressure member that is pressed with a predetermined pressure against the nip forming member with the fixing belt therebetween to form a fixing nip portion between the fixing belt and the pressure member,
the fixing device fixing, onto the recording medium, the toner image having been transferred by the transfer device onto the recording medium,
wherein
the image forming apparatus uses the magnetic one-component toner according to claim 1.
